(19) United States
(12) Patent Application Publication
(10) Pub. No.: US 2009/0113725 A1
(43) Pub. Date: May 7, 2009

(54) Utility knife with retractable blade

(76) Inventor: Dominick DeLillo, Delray Beach, FL (US)

Correspondence Address: MELVIN K. SILVERMAN AND ASSOCS PC, 500 WEST CYPRESS CREEK ROAD, SUITE 350, FT. LAUDERDALE, FL, 33309, US

(21) Appl. No.: 12/316,831

(22) Filed: Dec. 17, 2008

Related U.S. Application Data
(63) Continuation-in-part of application No. 11/936,402, filed on Nov. 7, 2007.

(51) Int. Cl. B26B 1/08

(52) U.S. Cl. 30/335

(57) ABSTRACT

An improved utility knife has a blade housing, a handle region, and an end cap. The end cap is removably attached to the handle region. The handle region is cylindrical, with a slight taper and includes an interior storage chamber. The blade housing has a blade channel for permitting retraction and extension of the blade. Clench plates hold the blade securely within the blade channel and are slidable within it. An axis of the blade-holding portion of the knife is tilted relative to the axis of the gripping portion.

### CROSS REFERENCE TO RELATED APPLICATION

This application is a continuation-in-part of patent application Ser. No. 11/936,402, filed on Nov. 7, 2007, which is herein incorporated by reference in its entirety.

### BACKGROUND OF THE INVENTION

1. Field of the Invention

The present invention relates to an improved utility knife designed for a variety of uses. Specifically, the invention provides a utility knife having a handle that is easily held firmly by an operator and directs the force of the operator's grip in the direction of the knife blade, while also stabilizing the blade, and having a blade that is retractable.

2. Prior Art

Typical utility knives of the prior art include a parallelepiped handle and have an approximately rectangular cross section, may be seen in U.S. Pat. Nos. 6,907,668, 7,131,204, 6,865,816 and 6,951,055. They may have either a stationary or retractable blade. It is common for replacement blades to be stored within the handle. The replacement blades are usually accessed by opening the handle, which is usually made of two halves held together by a screw, as shown in U.S. Pat. No. 7,186,067.

The typical shape of a utility knife handle does not provide the most ergonomically effective design for firmly grasping a knife and stabilizing a knife or transferring force applied by the hand of an operator to the blade of the knife. When a relatively large amount of force must be applied, and operator's hand may easily tire or slip along the handle. This ergonomic and mechanical inefficiency also provides a utility knife difficult for persons having decreased strength of grip, as commonly comes with increasing age. As life expectancy increases, it becomes more desirable to develop common household hand tools that are easily operated by persons with a relatively weaker grip.

Attempts have been made to improve the design of utility knife handles, as can be seen in U.S. Pat. No. 6,829,827, which employs a pistol-grip type handle. Such a design is only moderately effective but greatly increases the bulk of the knife, making it less practical for inclusion in a readily portable, compact tool box.

Because strong force is frequently applied to utility knives, it has been necessary to form them from strong, durable materials such as metals. More recently, it has become more practical to form utility knives from polymer and/or composite materials. These materials typically have smooth surfaces, increasing the difficulty of adequately gripping the handle. Such handles slip within an operator's grasp. In addition, the cast metal surface of such handles leads to blisters. More comfortable and more easily grasped plastics usually do not provide sufficient strength to the tool to be adequate material for manufacturing utility knives.

It is known to apply various coatings to the handle of a utility knife to increase gripping, as shown in U.S. Pat. Nos. 7,186,067 and 7,055,407. However, applying additional coatings during manufacture adds significant cost to production of the knives.

### SUMMARY OF THE INVENTION

The inventive retractable blade utility knife includes (a) substantially cylindrical handle region radially symmetrical about a first axis, having a back end, a front end, a plurality of circumferentially alternating axially disposed ribs and furrows; (b) a blade housing integral with a front end of the handle region, the region having an elongate blade channel, said channel comprising an upper wall, a lower wall and a clenching plane, said front end defining a second axis having a downward tilt relative to said first axis; (c) a clench plate assembly for securing a blade within the blade housing, said assembly including a tab for the selectable extension or retraction with said channel; and (d) a fastener passing a through a bore in the clench plate assembly and removably attachable to a bore in the blade channel, in which the clench plate assembly is tightened to firmly secure a blade within the blade channel and may be loosened to facilitate replacement of the blade.

It is an object of the invention to provide an improved utility knife having an easily gripped handle having a retractable blade and a blade housing having relatively few moving parts.

It is also an object to provide an improved utility knife having an ergonomically effective handle.

It is another object to provide an improved utility knife having a handle that is easily gripped firmly.

It is a further object to provide a utility knife handle that effectively transfers force from an operator's hand to the blade of the knife.

It is a yet further object to provide a utility knife that can withstand the application of strong force, but that is made of a lightweight and inexpensive material.

It is another object to provide a utility knife having a handle within which extra blades may be stored.

The above and yet other objects and advantages of the present invention will become apparent from the hereinafter set forth Brief Description of the Drawings, Detailed Description of the Invention, and Claims appended herewith.

### BRIEF DESCRIPTION OF THE DRAWINGS

FIG. 1 is a side perspective view of the inventive retractable blade utility knife showing the blade extended.

FIG. 2 is a side view of the knife of FIG. 1 however showing the blade thereof retracted.

FIG. 3 is a top view of the invention, as shown in FIG. 1.

FIG. 4 is a bottom view of the invention, as shown in FIG. 1.

FIG. 5 is a side elevational view of the utility knife.

FIG. 6 is a side elevational view of the opposite side of that shown in FIG. 5.

FIG. 7 is a rear elevational view of the invention.

FIG. 8 is a front elevational view thereof.

FIG. 9 is an exploded view showing the rear blade cover cap and the carrier, clench plate and blade assembly retaining means of the utility knife.

### DETAILED DESCRIPTION OF THE INVENTION

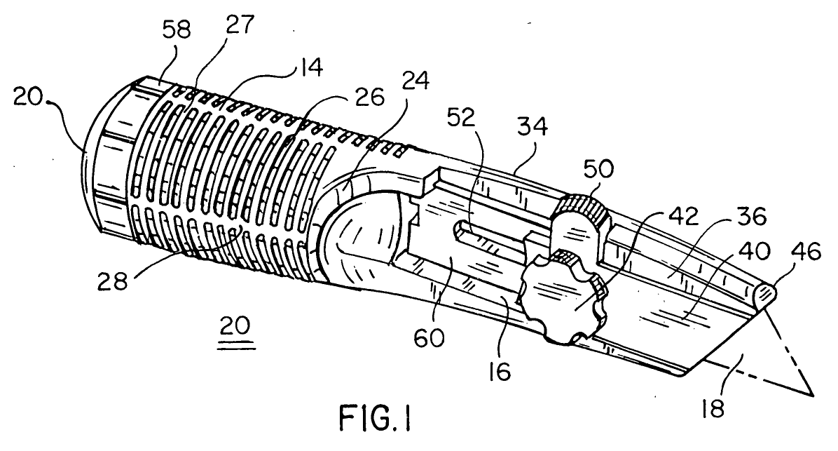

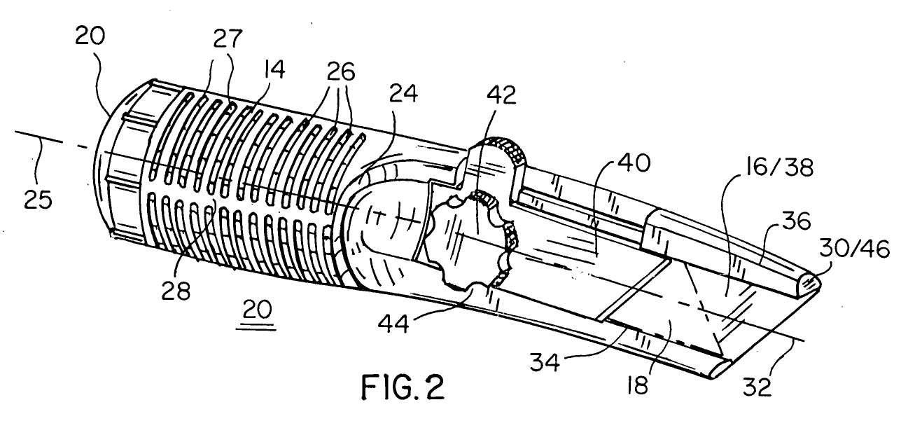

The present invention relates to an improved retractable blade utility knife having a central handle 14 that is generally cylindrical and tapered toward the front toward a knife blade 18. See FIG. 1. The handle is designed for superior effect of gripping and accuracy of directing applied force. It also includes a blade housing 16 that firmly holds blade 18 in place at a slight downward angle relative to an axis 25 of handle 14. See FIG. 2. The invention also preferably comprises an end cap 20 that is geometrically optimized to forwardly direct applied force. The features of the improved utility knife allow it to be made inexpensively and to efficiently direct and leverage applied force through the end cap 20, handle 14 and to the blade 18. It is relatively light in weight, has an easily gripped handle, and force-directing features make that make it suitable for use by any user, but also particularly for users having a weakened grip, such as sufferers of arthritis.

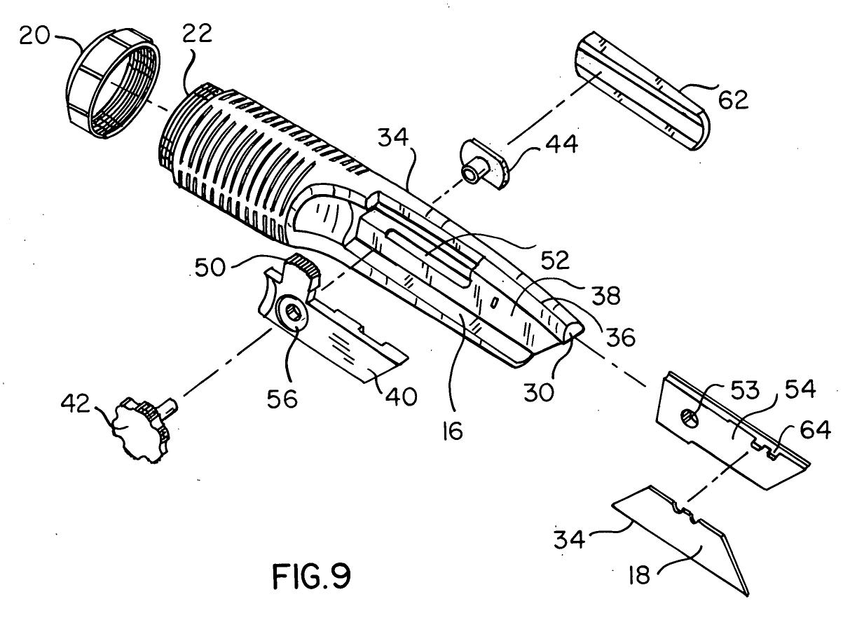

FIG. 1 shows a perspective view of the preferred embodiment of the invention. Utility knife 20 includes a blade housing 16, a handle region 14 and end cap 20. End cap 20 is removably attached to handle region 14. Both end cap 20 and handle region 14 have a diameter of about 29 to 49 millimeters, but preferably 39 mm. Handle region 14 is preferably about 35 to 54 millimeters, but preferably 44 mm in length (See FIG. 1) and is substantially radially symmetric. Region 14 also includes an interior storage chamber 22 (see FIG. 9) accessible by the removal of end cap 20. Blade housing 16 is designed to employ a standard utility knife blade 18. It may be made of steel or an inexpensive polymeric material, such as polyolefins, polycarbonates, composite materials or the like. The design of the knife allows less expensive material to be used to manufacture it while still producing a knife capable of withstanding the forces and torques commonly applied to a knife.

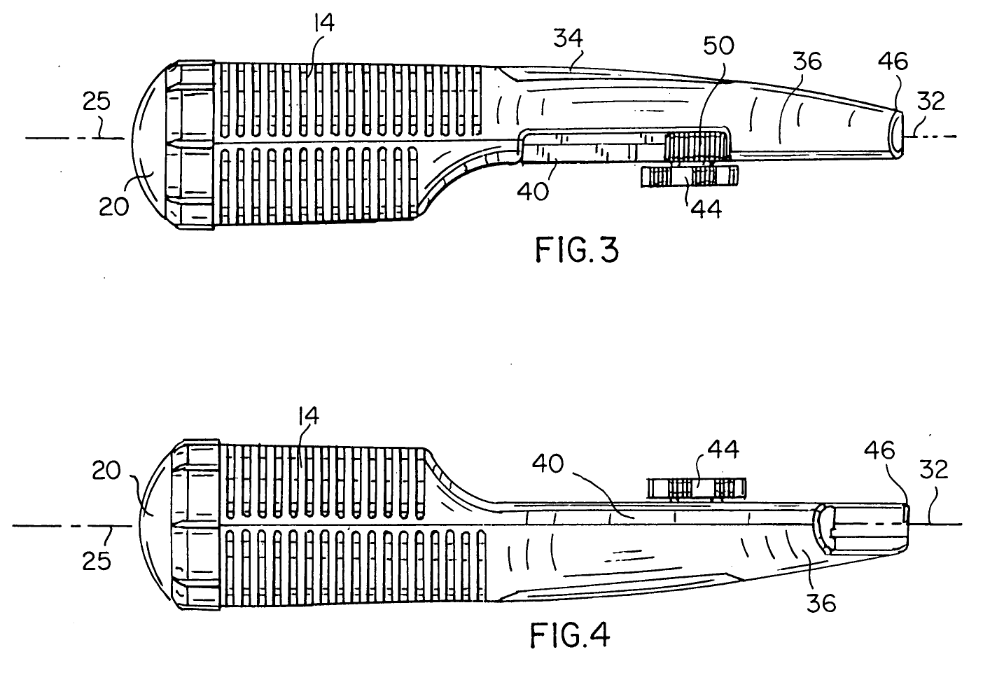

Referring to FIGS. 2 and 3, handle 14 extends from the back of the end cap 20 to the front 24 of handle 14. Handle 14 is cylindrical and slightly tapered such that the diameter at the front of handle is slightly less than the diameter at the end cap 20. In the view of FIG. 3, the longer side of handle 14 is in a range of 45 to 75 mm, but preferably 60 mm. Handle 14 is radially symmetric about an axis 25. Preferably, handle 14 tapers such that it is slightly frusto-conical in shape. However, it may also be cylindrical, having a constant radius along its length. In one embodiment, the radius gradually declines from about 20 mm at the back of the handle to about 16 mm at the front of handle, and the entire length of the utility knife 20 is about 185 mm, with a possible range of 140 to 230 mm.

A plurality of circumferential ridges 26 surround the exterior of handle 14 perpendicular to axis 25, thereby corrugating handle 14. Ribs 26 substantially strengthen utility knife 10, increasing the amount of force and torque that may be applied to and through it. Ribs 26 and alternating furrows 27 provide an exterior surface of handle 14 that facilitates superior gripping. The corrugated surface created by alternating ribs 26 and furrows 27 prevent an operator's hand from slipping up or down the handle region along axis 25. Ribs 26 and furrows 27 are preferably between 2 and 3 millimeters wide. Ribs 26 preferably extend between 2 and 3 millimeters above furrows 27. Ribs 26 are rigid and preferably made from the same material as the rest of the handle 14. Ribs 26 work synergistically with an optimized diameter of the handle to allow extremely effective gripping by a user. The strength of grip facilitated by these and other features of the handle are substantial and allow one with a relatively weak grip to effectively hold and manipulate the utility knife 20.

Handle 14 also preferably incorporates a plurality of longitudinal channels 28. In this embodiment, four longitudinal channel 28 extend across handle region 14 parallel to axis 25 and equidistantly spaced approximately 90 degrees apart from another. Longitudinal channels 28 provide additional strength to the utility knife 20 without interfering with the gripping action facilitated by ribs 26 which have a width of about 2 mm. Preferably, about three to eight longitudinal channels 28 are evenly spaced about the circumference of the handle. In the embodiment shown, four channels 28 are spaced 90 degrees apart, extend the entire length of the handle 14 and have substantially the same dimensions as rib furrows 27. In the preferred embodiment, longitudinal channel 28 (see FIG. 1) is approximately 2 millimeters wide and extends about two millimeters above furrows 27. The ribs 26 and furrows 27 are therefore both about 2 mm in width.

Blade housing 16 extends from front 24 of handle 14 to a front end 30 of the entire assembly. Blade housing 16 is centered about forward axis 32. Blade 18 is parallel to axis 32 which is angled slightly relative to the axis 25 of radial symmetry of the handle 14. Axis 25 and Axis 32 deviate from one another by a range of about 6 to about 10 degrees, and preferably about 9 degrees. This angle facilitates transfer of force, by a lever effect, through utility knife 20 to the edge 34 of blade 18. Blade housing 16 (see FIG. 9) is comprised of a blade housing body 36 which includes a blade channel 38. Blade 18 is inserted into blade carrier 54. Once blade 18 is properly placed on carrier 54, clench plate 40 is placed against carrier 54 and both can then slide within channel 38 such that blade 18 lies between the clench plate and blade carrier 54 but in blade housing body 36. Screw 42 defines an axis 66 centered about a point along axis 32 and is used to secure clench plate 40 tightly into channel 38 to firmly hold the blade in place. In this preferred embodiment, screw 42 also provides an easy method for loosening clench plate 40 and carrier 54. This method requires few moving parts and the large diameter of screw 42 provides effective contact to be made with its knurled edge. The large diameter of screw head 42 also allows an operator to provide sufficient torque force to tighten the screw even when applying relatively little torque force to its edges. Screw head 42 is preferably about 15 to 25 millimeters wide, and preferably 20 mm wide, and mates with female fastener 44 that is covered by plate 62 during use. See FIGS. 6 and 9.

Blade channel 38, blade carrier 54, and clench plate 40 are typically smooth, without a corrugated or other pattern upon their surfaces. See FIGS. 8 and 9.

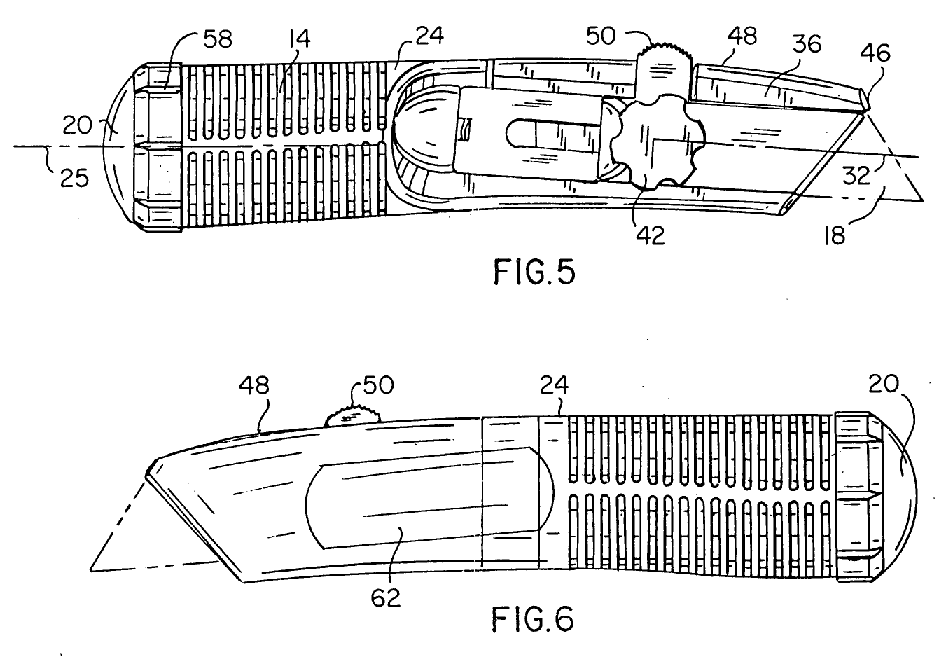

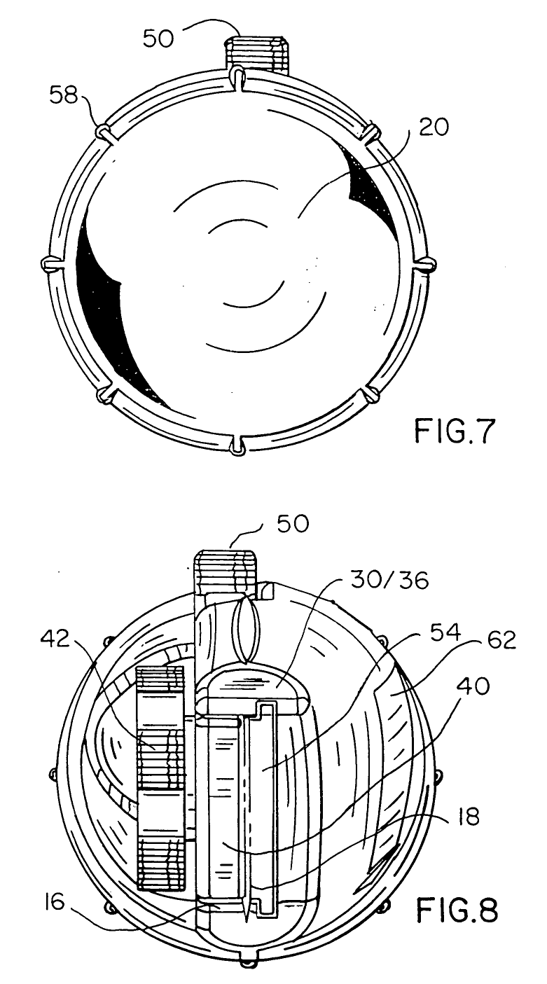

FIGS. 3 and 4 show top and bottom views of the embodiment shown in FIGS. 1-2. In these figures, it can be seen that axes 35 and 32 both lie in the plane of bilateral symmetry of the blade housing 36, and therefore do not deviate to either side in the invention. It may also be seen in FIG. 5 that blade housing 36 tapers downwardly between front 24 of handle 14 and the front 46 of the entire structure. The angle of tapering is substantially greater in blade region 48 (see FIG. 6) than the tapering of handle 14 between end cap 20 and the front 24 of handle 22. Handle 14 tapers less in order to provide a region that optimally engages an operator's hand. Blade housing 36 tapers more sharply. The tapering of both handle 14 and blade housing 36 directs a maximum force applied by an operator through handle 14 into blade 18. This tapering effect maximizes the efficiency with which force applied to handle 14 is transferred to blade 18. Additionally, the curving of the utility knife 10 resulting from the divergence of axis 25 from axis 32 provides a leverage that further enhances the effective transfer of force from handle 14 to blade 18 due to the physiology of the hand and forearm. This allows an operator with a weaker grip to apply a substantial amount of force to the blade 18 to adequately perform the various functions for which a utility knife is commonly used. Furthermore, the radially symmetric tapering of both the handle and the blade housing provide strength to the utility knife 20 and facilitates a more even distribution of force throughout the knife and into the blade.

It is noted that end cap 20 is radially symmetrical about axis 25. See FIGS. 5-6. The cap may define any of a variety of shapes, but is preferably hemispherical in shape and preferably has a series of axial strengthening ribs 58 spaced about it. A preferred hemispherical shape provides for even distribution of any force applied to the end cap 20 to the rest of the utility knife. Furthermore, a hemispherical shape of end cap 20 results in any force applied to it that leads to partially providing force in the direction of the front of the utility knife 20 and into blade 18.

Handle region 14 is preferably 3 to 5 centimeters in diameter, preferably about 4 centimeters in diameter. This results in a handle that is larger than many of the handles described in the prior art. A cylindrical handle of this size is very well suited to conform with the natural size and radius of curvature of a human hand, enabling it to be more easily grasped. This allows a person with even a weak grip to firmly hold and manipulate the tool. The tapering of the handle region further aids in preventing the knife from slipping through an operator's grasp in the direction of the front 46 of the knife 20. Often when using the knife as a cutting instrument, substantial force pulls it in the direction of the front of tool. The tapering of handle region allows an operator to counter such a force effectively by simply maintaining the natural shape of one's hand about it.

FIG. 9 is an exploded view showing bore 56 of clench plate 40, which permits screw 42 to engage thru it and slot 52 and also thru hole 53 of blade carrier 54 so that the screw tightly secures clench plate 40 into clench assembly channel 38 and to nut 44. This combination assures that carriers 40 and 54 are slidably compressed within channel 38, such that tab 50 may be effectively used to control the position of the blade. Screw 42 mates with nut 44, which is held in place by cover 62. The nut is formed of metal or durable polymer and inserted into a clench plate assembly slot 52 formed in housing body 36.

FIGS. 3, 4 and 9 also show tab 50 of clench plate 40. Nut 44 passes thru slot 52 in housing 34, aperture 53 in blade carrier 54, and hole 56 in clench plate 40 to firmly hold the clench plate 30 blade channel 38. Those skilled in the art will appreciate that a variety of screw head designs may also be used that are easily grasped, such as, but not limited to knobs, dials, shoulder type thumbscrews, winged thumbscrews, and cranks. FIG. 9 also shows housing 36 including outer clench plate 40, blade carrier plate 54, rear plate 62 and blade channel 38, and blade portion 34. Blade channel 38 is defined by channel housing 36 and engaging shelf 16. Indentions 64 in blade carrier plate 54 aid in securing knife 18. Tab 50 of outer clench plate 40 enables the user to advance or retract blade 18 and inner clench plate 54 within channel 38, as desired, in slot 52.

These void spaces of blade channel 38 reduce the amount of material required to manufacture the present invention, however having little effect on the function of the invention.

While there has been shown and described the preferred embodiment of the instant invention it is to be appreciated that the invention may be embodied otherwise than is herein specifically shown and described and that, within said embodiment, certain changes may be made in the form and arrangement of the parts without departing from the underlying ideas or principles of this invention as set forth in the Claims appended herewith.

1. A retractable blade utility knife, comprising:
(a) a substantially cylindrical, handle region radially symmetrical about a first axis, having a back end, a front end, a plurality of circumferentially alternating axially disposed ribs and furrows;
(b) a blade housing integral with a front end of the handle region, the region having an elongate blade assembly channel, said channel comprising an upper wall, a lower wall and a clenching plane, said front end defining a second axis having a downward tilt relative to said first axis;
(c) a clench plate assembly for securing a blade within the blade housing, said assembly including a tab for the selectable extension or retraction of the assembly with said channel; and
(d) a fastener passing a through a bore in the clench plate assembly and removably attachable thru a slot in the blade assembly channel.

2. The utility knife of claim 1, in which the handle region comprises a greatest dimension of about 60 mm.

3. The utility knife of claim 2, in which the handle region tapers from a diameter of about 40 mm at a back end to a diameter of about 33 mm at its front end.

4. The utility knife of claim 1 in which in the circumferential ribs and furrows each have widths of about 2 millimeters.

5. The utility knife of claim 1 wherein the end cap is substantially hemispherical.

6. The utility knife of claim 5 wherein the end cap further comprises a plurality of axial ribs.

7. The knife of claim 1 wherein said second axis of the knife forms a downward angle of about 6 to about 12 degrees relative to said first axis in the handle region.

8. The utility knife of claim 1 in which the blade channel further comprises:
an engaging shelf parallel to the clenching surface, and separated from the clenching surface by a shoulder, the clench plate comprising an engaging surface corresponding to the engaging shelf of the blade channel, the clenching surface corresponding to the clenching surface of the blade channel, and a ridge corresponding to the shoulder of the blade channel.

9. A retractable utility knife including an elongate handle having a central longitudinal axis, said knife comprising:
(a) a removable hollow end piece having a form substantially of a semi-hemisphere and having an equatorial cross-section thereof, said semi-hemisphere including an open end having a circumferential series of longitudinal ridges on a part thereof;
(b) a central portion having proximal and a distal ends thereof, said proximal end including means for complemental engagement with said open end of said handle, said central portion defining a conical section having an axial tangent of between about 6 and about 12 degrees relative to said central axis of said handle, said central portion having a greater diameter at said proximal end thereof than at said distal end thereof, said central portion including an axial sequence of circumferential ridges and furrows disposed on a lateral surface of said conical section;
(c) a distal end of said utility knife integrally depending from said distal end of said central portion, said distal end defining an axis displaced angularly downward from said central axis of said handle; and
(d) an assembly within said distal end for securing said blade and selectably extending or retracting it within an elongate recess substantially co-axial with said axis of said distal end.

10. The utility knife as recited in claim 9, in which a diameter of said semi-hemisphere, at its greatest dimension, falls within a range of about 30 to about 50 millimeters.

11. The utility knife as recited in claim 10, in which a greatest diameter of said distal end of said central portion falls in a range of about 29 to about 39 millimeters.

12. The utility knife as recited in claim 9, in which said ridges of said axial sequence of circumferential ridges are spaced apart from each other by a dimension in a range of about 2 millimeters.

13. The utility knife as recited in claim 12, in which the ratio of width to depth of said ridges and furrows falls in a range of about one-to-one.

14. The utility knife as recited in claim 13, in which a ratio of longitudinal width to separation of said ridges and furrows falls within a range of about one-to-one.

15. The utility knife as recited in claim 14, in which a ratio of longitudinal separation to depth of said ridges and furrows falls in a range of about one-to-one.

16. The utility knife as recited in claim 9, in which said blade securing assembly within said recess includes planar blade-holding clench plates positioned in said elongate recess and a fastener for said plates to provide stability to said blade within said assembly.

17. The utility knife as recited in claim 9, in which said proximal end of said central portion includes a hollow region sufficient in size to store replacement blades of the utility knife when said semi-hemispherical end is complementally secured to said proximal end of said central portion.

18. The utility knife as recited in claim 9, in which said distal end reduces in width toward the direction of said vertical plane of said handle in the direction of a distal end of said knife.

19. The utility knife as recited in claim 16, in which said recess includes means for securing said blade along a predetermined axis defining said axial tangent.
